(19) United States
(12) Patent Application Publication
(10) Pub. No.: US 2024/0304846 A1
(43) Pub. Date: Sep. 12, 2024

(54) PLANT-BASED ELECTROCHEMICAL DEVICE AND METHOD FOR ECOLOGICAL RESTORATION OF POLLUTED RIVER OR LAKE

(71) Applicants: JIMEI UNIVERSITY, Xiamen (CN); CCCC SDC (FUJIAN) COMMUNICATION CONSTRUCTION ENGINEERING CO., LTD, Xiamen (CN); TIANJIN UNIVERSITY, Tianjin (CN)

(72) Inventors: Jiarui QI, Xiamen (CN); Xiaohua WANG, Xiamen (CN); Jinfeng ZHANG, Xiamen (CN); Xiao LI, Xiamen (CN); Jiayu CHEN, Xiamen (CN); Lingling XU, Xiamen (CN); Fulai ZHUANG, Xiamen (CN); Chenghong WU, Xiamen (CN); Chen YE, Xiamen (CN); Qichen LIN, Xiamen (CN)

(73) Assignees: JIMEI UNIVERSITY, Xiamen (CN); CCCC SDC (FUJIAN) COMMUNICATION CONSTRUCTION ENGINEERING CO., LTD, Xiamen (CN); TIANJIN UNIVERSITY, Tianjin (CN)

(21) Appl. No.: 18/280,680

(22) PCT Filed: May 4, 2023
(86) PCT No.: PCT/CN2023/092020

§ 371 Date: Sep. 7, 2023

(30) Foreign Application Priority Data
May 5, 2022 (CN) 202210479745.5

(51) Int. Cl. H01M 8/16; C02F 3/00; C02F 3/32; C02F 103/00; H01M 4/96

(52) U.S. Cl. CPC H01M 8/16; C02F 3/005; C02F 3/327; H01M 4/96; C02F 2103/007; C02F 2201/46105

(57) ABSTRACT

A plant-based electrochemical device for ecological restoration of a polluted river or lake and a using method thereof are provided. The plant-based electrochemical device includes a sediment, where a plurality of first electrodes are provided in the sediment, the plurality of first electrodes each include a plurality of staggered cylinders, an outer side of each of the plurality of cylinders is provided with an electrically-conductive layer, and the electrically-conductive layer is electrically connected to an external power supply; a plurality of upright posts are symmetrically fixed in the sediment, the plurality of upright posts are fixedly connected to a second electrode through a fixing mechanism, and the second electrode is located at a water surface and is electrically connected to the external power supply; and a plurality of ecological landscape floating islands are provided on the water surface.

### CROSS REFERENCE TO THE RELATED APPLICATIONS

This application is the national phase entry of International Application No. PCT/CN2023/092020, filed on May 4, 2023, which is based upon and claims priority to Chinese Patent Application No. 202210479745.5, filed on May 5, 2022, the entire contents of which are incorporated herein by reference.

### TECHNICAL FIELD

The present disclosure relates to the technical field of pollution control, and in particular to a plant-based electrochemical device and method for ecological restoration of a polluted river or lake.

### BACKGROUND

Industrial wastewater and domestic wastewater usually include a large number of pollutants, and these pollutants enter a river or lake in large quantities through wastewater discharge, flushing, and rainfall, resulting in pollution of water in the river or lake. A large number of pollutants in the water will gradually be deposited into silt at the bed of a river or the bottom of a lake. When a water pollution management project is conducted at two sides of a river or lake, pollutants in the sediment of the river or lake will diffuse into the overlying water, resulting in secondary pollution. Therefore, treatment of the sediment rich in pollutants is required for pollution control of a river or lake.

Traditionally, the silt treatment is often conducted by an ex-situ treatment method, where the sediment of a river or lake is mechanically dredged; the dredged sediment is dewatered, solidified, and filled; and resulting water is subjected to a flocculating settling treatment with a chemical agent and then discharged back to the river or lake. This method is quick and effective, but will cause a severe disturbance to the water environment, aggravate the secondary pollution due to rapid release of sediment pollutants, and strongly destroy the ecological structure of the river bottom. Therefore, it is necessary to develop an environmentally-friendly, thorough, and effective sediment treatment method.

Some researchers have proposed that a sediment microbial fuel cell (SMFC) can be constructed to oxidize and decompose pollutants with microbial bacteria as a catalyst while outputting electric energy. In the SMFC, an anode is inserted into a sediment, a cathode is placed on a surface of overlying water, the cathode and the anode are connected and a resistor is connected through wires, and an electrode material is generally an electrically-conductive material such as graphite, carbon felt, and carbon cloth. Due to problems such as insufficient material strength, high cost, and insufficient efficiency, the SMFC cannot be easily used for on-site construction, and the bundling and hanging of a cathode material above a water surface will cause disharmony in a water-friendly view.

### SUMMARY

An objective of the present disclosure is to provide a plant-based electrochemical device and method for ecological restoration of a polluted river or lake to solve the problems in the prior art.

In order to achieve the above objective, the present disclosure provides the following solutions: The present disclosure provides a plant-based electrochemical device for ecological restoration of a polluted river or lake, including a sediment, where a plurality of first electrodes are provided in the sediment, the plurality of first electrodes each include a plurality of staggered cylinders, an outer side of each of the plurality of cylinders is provided with an electrically-conductive layer, and the electrically-conductive layer is electrically connected to an external power supply; a plurality of upright posts are symmetrically fixed in the sediment, the plurality of upright posts are fixedly connected to a second electrode through a fixing mechanism, and the second electrode is located at a water surface and is electrically connected to the external power supply; and a plurality of ecological landscape floating islands are provided on the water surface.

Preferably, the plurality of cylinders are hollow, an outer surface of each of the plurality of cylinders is provided with a plurality of first round holes, and the electrically-conductive layer is embedded inside the plurality of first round holes.

Preferably, the electrically-conductive layer is one selected from the group consisting of a carbon nanotube (CNT), graphene, and electrically-conductive graphite.

Preferably, the second electrode includes an electrode sheet, the electrode sheet is electrically connected to the external power supply, and a bottom of the electrode sheet is fixedly connected to the fixing mechanism.

Preferably, the electrode sheet includes a titanium mesh, and a graphite felt is fixed at each of two sides of the titanium mesh; and a nylon mesh is fixed at a side of the graphite felt away from the titanium mesh, and the fixing mechanism is fixed at a bottom of the nylon mesh located at a bottom of the titanium mesh.

Preferably, the fixing mechanism includes a connector fixed at a center of a bottom surface of the electrode sheet, and the connector is provided with a plurality of interfaces; a connecting pipe is fixed through a locking member inside and communicates with each of the plurality of interfaces, and the connecting pipe is fixed to the bottom surface of the electrode sheet; and a cable is provided in a manner of penetrating through the connector, and the cable penetrates through the connecting pipe and is fixed to the upright post.

Preferably, two float balls are fixed at two sides of the connecting pipe, respectively.

Preferably, the locking member includes a locking pipe; and one end of the locking pipe is fixed to and communicates with the connecting pipe, and the other end of the locking pipe is fixed through an elastic member to and communicates with the interface.

Preferably, a first groove is symmetrically formed in each of the plurality of interfaces; one end of a first spring is fixed inside the first groove, and the other end of the first spring is fixed to a limit base; the limit base is slidably connected to the first groove; and an outer wall of the locking pipe is provided with two limit rings, the two limit rings abut against the locking pipe, and an outer wall of each of the two limit rings abuts against an inner wall of the interface.

A method for using a plant-based electrochemical device for ecological restoration of a polluted river or lake is provided, including the following steps:
a. arranging a first electrode in a sediment;
b. preparing a second electrode, and connecting the second electrode to an upright post through a fixing mechanism; and
c. energizing the first electrode in step a and the second electrode in step b to work in coordination with an ecological landscape floating island.

The present disclosure discloses the following technical effects: In the present disclosure, a first electrode located in a sediment is set as an anode, and a second electrode located on a water surface is set as a cathode; a plurality of hollow cylinders that are easily pressed into the sediment are prepared with an electrically-conductive metal material and arranged in a staggering manner, and an electrically-conductive layer is provided at an outer side of each of the plurality of hollow cylinders, which increases a contact area between the first electrode and the sediment, facilitates the enrichment of microorganisms in the sediment, enhances the attachment and proliferation of microorganisms, increases a power of a fuel cell, and improves the decomposition efficiency of pollutants; and an ecological landscape floating island is provided to play roles of COD degradation, phosphorus removal, and nitrogen fixation for eutrophicated water, inhibit the growth of algae, and reduce a pollution load in water while improving the power generation efficiency of the device and the treatment efficiency of organic pollutants in the sediment through a radial oxygen loss (ROL) and a oxidation-reduction potential (ORP). In addition, the device of the present disclosure can also reduce the deposition of water pollutants into a sediment, improve the growth environments of animals and plants, recreate a natural ecological balance, and exert a strong environmental landscape function. In the present disclosure, the first electrode and the second electrode constitute a closed loop through the external power supply; when working with an external resistor, the device has a role of treating organic pollutants in a sediment; and when working with a power management system, the device can power a low-power electrical appliance through a boost, power storage, and discharge system while decomposing pollutants, which is in line with a concept of sustainable development.

### BRIEF DESCRIPTION OF THE DRAWINGS

To describe the technical solutions in the embodiments of the present disclosure or in the prior art more clearly, the accompanying drawings required in the embodiments are briefly introduced below. Apparently, the accompanying drawings in the following description show merely some embodiments of the present disclosure, and a person of ordinary skill in the art may still derive other accompanying drawings from these accompanying drawings without creative efforts.

FIG. 1 is a schematic structural diagram of the plant-based electrochemical device for ecological restoration of a polluted river or lake in the present disclosure;

FIG. 2 is a bottom view of an electrode sheet;

FIG. 3 is a schematic structural diagram of a locking member;

FIG. 4 is a schematic structural diagram of an electrode sheet; and

FIG. 5 is a schematic structural diagram of a cylinder.

Reference numerals: 1: sediment; 2: first electrode; 3: water surface; 4: second electrode; 5: external power supply; 6: cylinder; 7: electrically-conductive layer; 8: first titanium wire; 9: first wiring terminal; 10: first copper wire; 11: upright post; 12: electrode sheet; 14: ecological landscape floating island; 15: nylon mesh; 16: graphite felt; 17: titanium mesh; 18: connecting pipe; 19: connector; 20: float ball; 22: second titanium wire; 23: second wiring terminal; 24: second copper wire; 25: cable; 26: locking pipe; 27: first groove; 28: first spring; 29: limit base; and 30: limit ring.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

In order to make the above objective, features, and advantages of the present disclosure clear and comprehensible, the present disclosure will be further described in detail below in combination with accompanying drawings and specific implementations.

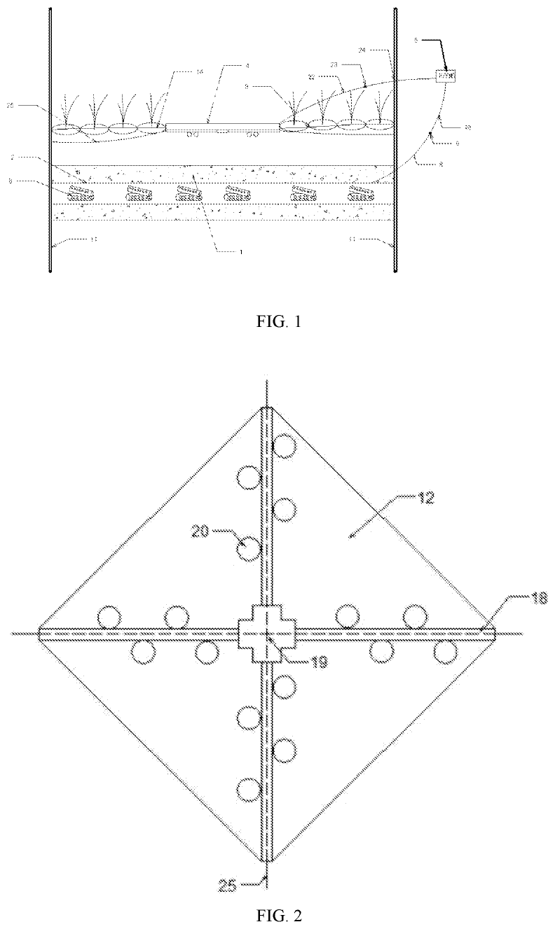

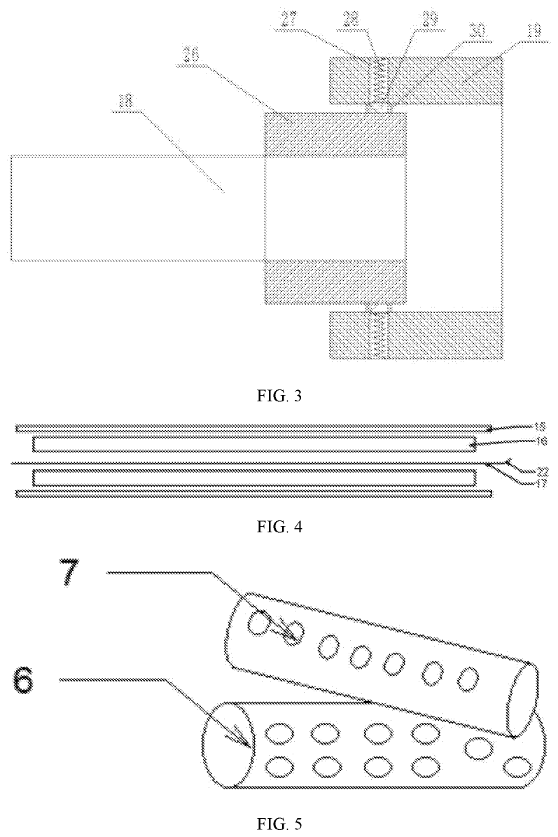

As shown in FIG. 1 to FIG. 5, the present disclosure provides a plant-based electrochemical device for ecological restoration of a polluted river or lake, including sediment 1, where a plurality of first electrodes 2 are provided in the sediment 1, the plurality of first electrodes 2 each include a plurality of staggered cylinders 6, an outer side of each of the plurality of cylinders is provided with electrically-conductive layer 7, and the electrically-conductive layer 7 is electrically connected to external power supply 5; a plurality of upright posts 11 are symmetrically fixed in the sediment 1, the plurality of upright posts 11 are fixedly connected to second electrode 4 through a fixing mechanism, and the second electrode 4 is located at water surface 3 and is electrically connected to the external power supply 5; and a plurality of ecological landscape floating islands 14 are provided on the water surface 3.

The first electrode 2 located in the sediment 1 is set as an anode, and the second electrode 4 located on the water surface 3 is set as a cathode; the plurality of hollow cylinders 6 that are easily pressed into the sediment are prepared with an electrically-conductive metal material and arranged in a staggering manner, and an electrically-conductive layer is provided at an outer side of each of the plurality of hollow cylinders 6, which increases a contact area between the first electrode 2 and the sediment 1, facilitates the enrichment of microorganisms in the sediment 1, enhances the attachment and proliferation of microorganisms, increases a power of a fuel cell, and improves the decomposition efficiency of pollutants; and the ecological landscape floating island 14 is provided to play roles of COD degradation, phosphorus removal, and nitrogen fixation for eutrophicated water, inhibit the growth of algae, and reduce a pollution load in water while improving the power generation efficiency of the device and the treatment efficiency of organic pollutants in the sediment through ROL and ORP. In addition, the device of the present disclosure can also reduce the deposition of water pollutants into a sediment, improve the growth environments of animals and plants, recreate a natural ecological balance, and exert a strong environmental landscape function.

As a further optimized solution, the plurality of cylinders 6 are hollow, an outer surface of each of the plurality of cylinders 6 is provided with a plurality of first round holes, and the electrically-conductive layer 7 is embedded inside the plurality of first round holes. One end of first titanium wire 8 with a diameter of 1.5 mm is inserted into the cylinder 6 along a side wall, and the other end of the first titanium wire is led to a shore and is connected to first copper wire 10 through first wiring terminal 9 to produce a titanium-copper lead wire, and the titanium-copper lead wire is connected as a negative electrode of a battery to an end of the external power supply 5.

As a further optimized solution, the electrically-conductive layer 7 is one selected from the group consisting of a CNT, graphene, and electrically-conductive graphite.

As a further optimized solution, the second electrode 4 includes electrode sheet 12, the electrode sheet 12 is electrically connected to the external power supply 5, and a bottom of the electrode sheet 12 is fixedly connected to the fixing mechanism.

Second titanium wire 22 is fixed to the second electrode 4, and the second titanium wire is electrically connected to the external power supply 5 through second wiring terminal 23 and second copper wire 24.

As a further optimized solution, the electrode sheet 12 includes titanium mesh 17, and graphite felt 16 is fixed at each of two sides of the titanium mesh 17; and nylon mesh 15 is fixed at a side of the graphite felt 16 away from the titanium mesh 17, and the fixing mechanism is fixed at a bottom of the nylon mesh 15 located at a bottom of the titanium mesh 17.

The titanium mesh 17 is produced by weaving a mesh structure with a titanium wire, where two sides of the titanium mesh 17 each are covered with graphite felt 16, nodes are fixed with a fine titanium wire, and after the fine titanium wire is interwoven and stitched in the titanium mesh, the two outsides of the graphite felt 16 are covered with 4-mesh nylon mesh 15, and the nylon mesh is stitched and fixed with a fishing thread. A side of the titanium mesh is reserved as long second titanium wire 22, and the long second titanium wire is led to a shore and is connected to second copper wire 24 through second wiring terminal 23 to produce a titanium-copper lead wire, and the titanium-copper lead wire is connected as a positive electrode of a battery to an end of the external power supply 5. The titanium mesh 17 can enhance the electric conductivity of an electrode, maintain a shape of the electrode sheet 12, and easily lead out the second titanium wire 22 to form a closed loop; as a main body of an air cathode, the graphite felt 16 can increase a supply of O₂ and a reaction area; and the nylon mesh 15 covers the outermost side to make up for an insufficient physical strength of the graphite felt 16 and provide a firm force-bearing point for the fixing mechanism. The fixing mechanism under the electrode sheet 12 provides fixing and buoyancy supports for a central zone of an air cathode to ensure that a surface of the electrode sheet 12 is exposed to air and a floating position is centered and relatively stable.

As a further optimized solution, the fixing mechanism includes connector 19 fixed at a center of a bottom surface of the electrode sheet 12, and the connector 19 is provided with a plurality of interfaces; connecting pipe 18 is fixed through a locking member inside and communicates with each of the plurality of interfaces, and the connecting pipe 18 is fixed to the bottom surface of the electrode sheet 12; and cable 25 is provided in a manner of penetrating through the connector 19, and the cable 25 penetrates through the connecting pipe 18 and is fixed to the upright post 11.

As a further optimized solution, two float balls 20 are fixed at two sides of the connecting pipe 18, respectively.

The connector 19 is fixed to the connecting pipe 18 through the locking member, two cables 25 are knotted and fixed at midpoints to form a cross shape and then placed in the connector 19, and the cables 25 penetrate through the connecting pipe 18 and are fixed to the upright post 11.

As a further optimized solution, the locking member includes locking pipe 26; and one end of the locking pipe 26 is fixed to and communicates with the connecting pipe 18, and the other end of the locking pipe 26 is fixed through an elastic member to and communicates with the interface.

As a further optimized solution, first groove 27 is symmetrically formed in each of the plurality of interfaces; one end of first spring 28 is fixed inside the first groove 27, and the other end of the first spring 28 is fixed to limit base 29; the limit base 29 is slidably connected to the first groove 27; and an outer wall of the locking pipe 26 is provided with two limit rings 30, the two limit rings 30 abut against the locking pipe 26, and an outer wall of each of the two limit rings 30 abuts against an inner wall of the interface.

The connecting pipe 18 and the locking pipe 26 are inserted, and the locking pipe 26 is inserted into the interface; and after the limit rings 30 of the locking pipe 26 slide to an inner side of the limit base 29, under an action of the first spring 28, the limit base 29 slides downwards along the first groove 27 and abuts against an outer wall of the locking pipe 26 to fix the locking pipe 26.

A method for using a plant-based electrochemical device for ecological restoration of a polluted river or lake is provided, including the following steps:
a. First electrode 2 is arranged in sediment 1.

A plurality of cylinders 6 are arranged in the sediment 1 in a staggering manner, and an electrically-conductive layer is arranged at an outer side of each of the plurality of cylinders 6, which increases a contact area between the first electrode 2 and the sediment 1, facilitates the enrichment of microorganisms in the sediment 1, enhances the attachment and proliferation of microorganisms, increases a power of a fuel cell, and improves the decomposition efficiency of pollutants.
b. Second electrode 4 is prepared and connected to upright post 11 through a fixing mechanism.

The titanium mesh 17 is produced by weaving a mesh structure with a titanium wire, where two sides of the titanium mesh 17 each are covered with a graphite felt 16, nodes are fixed with a fine titanium wire, and after the fine titanium wire is interwoven and stitched in the titanium mesh, the two outsides of the graphite felt 16 are covered with a 4-mesh nylon mesh 15, and the nylon mesh is stitched and fixed with a fishing thread. A side of the titanium mesh is reserved as long second titanium wire 22, and the long second titanium wire is led to a shore and is connected to second copper wire 24 through second wiring terminal 23 to produce a titanium-copper lead wire, and the titanium-copper lead wire is connected as a positive electrode of a battery to an end of the external power supply 5. The connector 19 is fixed to the connecting pipe 18 through the locking member, two cables 25 are knotted and fixed at midpoints to form a cross shape and then placed in the connector 19, and the cables 25 penetrate through the connecting pipe 18 and are fixed to the upright post 11.
c. The first electrode 2 in step a and the second electrode 4 in step b are energized to work in coordination with ecological landscape floating island 14.

The first electrode 2 and the second electrode 4 constitute a closed loop through the external power supply 5; when working with an external resistor, the device has a role of treating organic pollutants in a sediment; and when working with a power management system, the device can power a low-power electrical appliance through a boost, power storage, and discharge system while decomposing pollutants, which is in line with a concept of sustainable development.

It should be understood that, in the description of the present disclosure, terms such as “longitudinal”, “transverse”, “upper”, “lower”, “front”, “rear”, “left”, “right”, “vertical”, “horizontal”, “top”, “bottom”, “inside”, and “outside” indicate the orientation or position relationships shown in the accompanying drawings. These terms are merely intended to facilitate the description of the present disclosure, rather than to indicate or imply that the mentioned device or elements must have a specific orientation and must be constructed and operated in a specific orientation. Therefore, these terms should not be construed as a limitation to the present disclosure.

The above embodiments are only intended to describe the preferred implementations of the present disclosure, but not to limit the scope of the present disclosure. Various alterations and improvements made by those of ordinary skill in the art based on the technical solutions of the present disclosure without departing from the design spirit of the present disclosure shall fall within the protection scope of the appended claims of the present disclosure.

What is claimed is:

1. A plant-based electrochemical device for an ecological restoration of a polluted river or lake, comprising a sediment, wherein a plurality of first electrodes are provided in the sediment, each of the plurality of first electrodes comprises a plurality of staggered cylinders, an outer side of each of the plurality of staggered cylinders is provided with an electrically-conductive layer, and the electrically-conductive layer is electrically connected to an external power supply; a plurality of upright posts are symmetrically fixed in the sediment, the plurality of upright posts are fixedly connected to a second electrode through a fixing mechanism, and the second electrode is located at a water surface and is electrically connected to the external power supply; and a plurality of ecological landscape floating islands are provided on the water surface.

2. The plant-based electrochemical device for the ecological restoration of the polluted river or lake according to claim 1, wherein the plurality of staggered cylinders are hollow, an outer surface of each of the plurality of staggered cylinders is provided with a plurality of first round holes, and the electrically-conductive layer is embedded inside the plurality of first round holes.

3. The plant-based electrochemical device for the ecological restoration of the polluted river or lake according to claim 2, wherein the electrically-conductive layer is one selected from the group consisting of a carbon nanotube (CNT), a graphene, and an electrically-conductive graphite.

4. The plant-based electrochemical device for the ecological restoration of the polluted river or lake according to claim 1, wherein the second electrode comprises an electrode sheet, the electrode sheet is electrically connected to the external power supply, and a bottom of the electrode sheet is fixedly connected to the fixing mechanism.

5. The plant-based electrochemical device for the ecological restoration of the polluted river or lake according to claim 4, wherein the electrode sheet comprises a titanium mesh, and a graphite felt is fixed at each of two sides of the titanium mesh; and a nylon mesh is fixed at a side of the graphite felt away from the titanium mesh, and the fixing mechanism is fixed at a bottom of the nylon mesh located at a bottom of the titanium mesh.

6. The plant-based electrochemical device for the ecological restoration of the polluted river or lake according to claim 5, wherein the fixing mechanism comprises a connector fixed at a center of a bottom surface of the electrode sheet, and the connector is provided with a plurality of interfaces; a connecting pipe is fixed through a locking member inside and communicates with each of the plurality of interfaces, and the connecting pipe is fixed to the bottom surface of the electrode sheet; and a cable is provided in a manner of penetrating through the connector, and the cable penetrates through the connecting pipe and is fixed to the plurality of upright posts.

7. The plant-based electrochemical device for the ecological restoration of the polluted river or lake according to claim 6, wherein two float balls are fixed at two sides of the connecting pipe, respectively.

8. The plant-based electrochemical device for the ecological restoration of the polluted river or lake according to claim 7, wherein the locking member comprises a locking pipe; and a first end of the locking pipe is fixed to and communicates with the connecting pipe, and a second end of the locking pipe is fixed through an elastic member to and communicates with the plurality of interfaces.

9. The plant-based electrochemical device for the ecological restoration of the polluted river or lake according to claim 8, wherein a first groove is symmetrically formed in each of the plurality of interfaces; a first end of a first spring is fixed inside the first groove, and a second end of the first spring is fixed to a limit base; the limit base is slidably connected to the first groove; and an outer wall of the locking pipe is provided with two limit rings, the two limit rings abut against the locking pipe, and an outer wall of each of the two limit rings abuts against an inner wall of the plurality of interfaces.
